(19) United States
(12) Patent Application Publication
(10) Pub. No.: US 2017/0110759 A1
(43) Pub. Date: Apr. 20, 2017

(54) SOLID ELECTROLYTE

(71) Applicant: BASF SE, Ludwigshafen (DE)

(72) Inventors: Philipp Johannes BOECKMANN, Bad Duerkheim (DE); Christian KOENIG, Mannheim (DE); Sven FLEISCHMANN, Ludwigshafen (DE); Dejan PETROVIC, Osnabrueck (DE)

(73) Assignee: BASF SE, Ludwigshafen (DE)

(21) Appl. No.: 15/127,831

(22) PCT Filed: Mar. 20, 2015
(86) PCT No.: PCT/EP2015/055929

§ 371 Date: Sep. 21, 2016

(30) Foreign Application Priority Data
Mar. 21, 2014 (EP) 14160994.1

(51) Int. Cl. H01M 10/0565; H01M 10/0525

(52) U.S. Cl. CPC H01M 10/0565; H01M 10/0525; H01M 2300/0082; H01M 2300/0091

(57) ABSTRACT

A solid phase electrolyte composition containing at least one conducting salt and at least one random copolymer, wherein the random copolymer comprises 5 to 95 wt.-% polymerized units of monomers (a) and 95 to 5 wt.-% polymerized units of monomers (b), based on the total weight of the copolymer, wherein (a) is at least one functionalized polyether containing at least one polymerizable C—C double bond per molecule in average, and (b) is at least one ethylenically unsaturated monomer (b1) or a mixture of at least one ethylenically unsaturated monomer (b1) and at least one ethylenically unsaturated monomer (b2) wherein (b1) is selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylacrylic acids, salts of C₁-C₄ alkylacrylic acids, acrylic amides, and vinyl alcohol derivates, and (b2) is selected from the group consisting of acrylonitrile and methacrylonitrile.

The present invention relates to a random copolymer comprising monomer units derived from functionalized polyether(s) and ethylenically unsaturated monomer(s) and to a solid phase electrolyte composition containing such random copolymer and a conducting salt.

Storing electrical energy is a subject of still growing interest. Efficient storage of electric energy would allow electric energy to be generated when it is advantageous and used when needed. Secondary electrochemical cells are well suited for this purpose due to their rechargeability. Secondary lithium batteries are of special interest for energy storage since they provide high energy density due to the small atomic weight and the large ionization energy of lithium and have become widely used as a power source for many portable electronics such as cellular phones, laptop computers, mini-cameras, etc.

An electrochemical cell comprises an anode, a cathode, an electron insulating separator separating the two electrodes and electrolytes which are used to facilitate the necessary passage of ions between reduction and oxidation sites. One class of electrolytes are polymer electrolytes. Polymer electrolytes are roughly divided into two major classes, solid polymer electrolytes composed of a polymer or polymer mixture and conducting salt and polymer gel electrolytes composed of a polymer or polymer mixture gelled in a conventional liquid electrolyte mixture comprising solvent, conducting salt and possibly further additives.

There are many potential advantages in the use of solid polymer electrolytes, for example, adjustable physical properties such as flexibility, rigidity, processibility, softness, hardness, porosity, tackiness etc., low toxicity, minimal fire hazard, light weight, high energy density, lower manufacturing costs, improved performance, etc. Especially the absence of flammable organic solvents used in many electrolyte systems is a benefit in regard to the growing concerns about the safety of conventional electrolyte systems. A solid polymer electrolyte may also function as separator, thereby rendering the presence of a special separator dispensable.

Armand et al. found in 1978 that poly(ethylene oxide) (PEO) can dissolve lithium perchlorate salts forming a complex that can serve as a solid electrolyte. This complex has a relatively good ionic conductivity in solid state. However, the ionic conductivity is insufficient as compared with the ionic conductivity of the non-aqueous electrolyte solution and the cation transport number of the complex is extremely low.

Subsequently a broad range of solid polymer electrolytes were investigated, e.g. polyethylene oxide (co)polymers of different structures like graft polymers, block copolymers and crosslinked polymer networks, polysiloxanes and polyphosphazenes (Dials, F. B. et al., Journal of Power Sources 88 (2000), pages 169 to 191).

US 2006/0041075 A1 discloses a single ion conducting polymer prepared by grafting a salt compound onto a polymer containing double bonds. The polymer preferably comprises a comb-branch polymer having a hydrocarbon backbone and (poly)ether containing side chains.

EP 1 847 556 B1 describes polymer electrolytes comprising a block copolymer wherein one block is a copolymer of an alkoxy acrylic acid ester monomer and an ethylenically unsaturated monomer substituted by at least one functional group selected from hydroxyl, carboxyl, epoxy, acid anhydride, and amino and one block is an ethylenically unsaturated monomer containing an aromatic or heteroaromatic substituent.

However, the need remains for new solid phase polymer electrolytes having unique molecular architecture and/or new ion transport mechanisms that can provide good ion conductivity at room temperature without solvent and good mechanical properties.

Accordingly the present invention provides a solid phase electrolyte composition containing at least one conducting salt and at least one random copolymer, wherein the random copolymer comprises

5 to 95 wt.-% polymerized units of monomers (a) and

95 to 5 wt.-% polymerized units of monomers (b),

based on the total weight of the random copolymer,

wherein
(a) is at least one functionalized polyether containing at least one polymerizable C—C double bond per molecule in average, and
(b) is at least one ethylenically unsaturated monomer (b1) or a mixture of at least one ethylenically unsaturated monomer (b1) and at least one ethylenically unsaturated monomer (b2)
   wherein
   (b1) is selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylacrylic acids, salts of C₁-C₄ alkylacrylic acids, acrylic amides, and vinyl alcohol derivates, and
   (b2) is selected from the group consisting of acrylonitrile and methacrylonitrile.

The present invention further provides the use of the random copolymers as described above in electrochemical cells, electrochemical cells comprising the solid phase electrolyte described above, and the preparation of the random copolymers.

The inventive solid phase electrolyte composition shows good ionic conductivity, mechanical and thermal stability, excellent processability and electrochemical stability.

Solid phase electrolyte composition means that the electrolyte composition is present in the solid state, e.g. at processing temperature or the temperature of use, e.g. at room temperature. Preferably the solid phase electrolyte composition of the present invention contains less than 9 wt.-% of solvents, more preferred less than 8 wt.-% of solvents, even more preferred less than 5 wt.-% of solvents, even more preferred less than 2 wt.-% and most preferred less than 1 wt.-% of solvents, based on the total amount of the electrolyte composition. The term “solvent” is intended to mean solvents usually used in liquid electrolyte compositions or polymer gel electrolyte compositions like low molecular organic aprotic solvents, e.g. ethers like dimethoxyethane, carbonates like ethylene carbonate and dimethylcarbonate, organic esters like gamma-butyrolactone and propionic acid esters.

Monomers (a) are functionalized polyethers containing at least one polymerizable C—C double bond per molecule in average, i.e. the polyethers are functionalized by at least one polymerizable C—C double bond per molecule in average. Functionalized polyethers as used herein are polyethers containing at least one polymerizable C—C double bond per molecule in average.

The functionalized polyether (a) has at least one polymerizable C—C double bond per molecule in average, the functionalized polyether (a) may have one, two, three, four, five, six, seven, eight, nine, ten or more polymerizable C—C double bonds per molecule in average, preferably the functionalized polyether (a) has at exactly one polymerizable C—C double bonds per molecule in average. Functionalized polyethers (a) having one polymerizable C—C double bonds per molecule in average show no crosslinking or only a low degree of crosslinking in the copolymerization reaction with monomer(s) (b). Random copolymers having no or only a low degree of crosslinking are preferred according to the present invention since thin films of the copolymer can be prepared from solutions of the copolymer in a solvent. The use of functionalized polyethers (a) having more than one polymerizable C—C double bonds per molecule in average leads to crosslinking in the resulting random copolymers. Crosslinked polymers are less suited for the preparation of thin films from solutions of the copolymers, depending on the degree of crosslinking it might even be impossible to obtain a copolymer solution suited for the preparation of thin films of the copolymers.

The functionalized polyethers may be prepared by reacting a compound containing an ethylenically unsaturated double bond and one or more functional groups capable of reacting with the epoxide group of alkylene oxides or glycidyl ethers with alkylene oxides or glycidyl ethers or by reacting a polyether containing at least one OH group with a compound containing an ethylenically unsaturated double bond and one or more functional groups capable of reacting with OH groups. Preferably the functionalized polyether (a) is the reaction product of the reaction of at least one polyether (a1) having one or more OH-groups and at least one compound (a2) having at least one radically polymerizable C—C double bond and at least one group reactive with the at least one OH-group of the polyether (a1) and optionally subsequent permanent protection of remaining OH-groups by derivatization. Polyethers (a1) having more than one OH-group are also known as polyetherpolyols.

Polyether means according to the present invention that the polyether contains at least two consecutive ether groups in the main chain, preferably at least three consecutive ether groups and more preferred at least 5 consecutive ether groups in the main chain.

Methods of forming polyethers (a1) having one or more OH-groups are well known and described in the prior art. Polyethers (a1) may be polyglycidylethers or polyalkylene oxides.

Polyalkylene oxides are prepared by polyaddition of alkylene oxides with polyfunctional or monofunctional starter compounds containing reactive hydrogen(s). Typical Catalysts used for the addition reaction are alkali metal or alkaline earth metal hydroxide or alkoxylate catalysts, amine catalysts and double metal cyanide complex catalysts (DCM).

In principle, all suitable alkylene oxides can be used for preparing the polyalkylene oxides for use as polyether (a1). For example, C₂-C₂₀-alkylene oxides, such as, for example, ethylene oxide, propylene oxide, 1,2-butylene oxide, 2,3-butylene oxide, isobutylene oxide, pentene oxide, hexene oxide, cyclohexene oxide, dodecene epoxide, octadecene epoxide, and mixtures of these epoxides are suitable. Ethylene oxide, propylene oxide, 1,2-butylene oxide, 2,3-butylene oxide, and isobutylene oxide are particularly suitable, propylene oxide and ethylene oxide being particularly preferred. It is also possible to use tetrahydrofurans or epihalohydrins for the preparation of the polyalkylene oxides for use as polyether (a1).

Starter compounds used are, for example, water, alcohols, acids and amines or mixtures of these compounds. All compounds which have active hydrogen are suitable as the starter compound. According to the invention, OH-functional compounds are preferred as starter compounds. Starters may be polyhydric or monohydric alcohols or primary or secondary amines. Examples of polyhydric alcohol initiators include glycerol, 1,1,1-trimethylolpropane, 1,1,1-trimethylolethane, 1,2,6-hexanetriol, pentaerythritol, sucrose, sorbitol, ethylene glycol, 1,2- and 1,3-propanediol, diethylene glycol, dipropylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol. Also included within the term “polyhydric alcohol” are compounds derived from phenol such as 2,2-bis(4-hydroxyphenyl)propane, commonly known as Bisphenol A or from amines like triethanol amine, tri(2-propanolamine), and tri(3-propanolamine). Other suitable initiators for the polyalkylene oxides for use as polyethers (a1) of the present invention comprise hydrogenated starch hydrolysates, such as those available from Roquette under the tradename Lycasin®, which are derivatives of maltitol. Examples of initiator molecules containing primary amine are ethylenediamine, propylenediamine, vicinal toluenediamine, 2,6- or 2,4-substituted toluenediamine, and diphenylmethanediamine. Polyalkylene oxides for use as polyethers (a1) having one or more OH-groups may be prepared by any known process such as, for example, the process disclosed by WO 2011/012599 A1.

Preferred catalysts for the preparation of polyalkylene oxides for use as polyethers (a1) from alkylene oxides are potassium hydroxide, sodium hydroxide, alcoxylates of potassium hydroxide, alcoholates of sodium hydroxide, cesium hydroxide, amines, Lewis acid catalysts, or double metal cyanide complex catalysts (DMC), all of which are known in the art.

Linear polyglycidylethers for use as polyethers (a1) may be prepared via anionic ring-opening polymerization of glycidyl ethers, branched polyglycidylethers for use as polyethers (a1) may be prepared by polymerization of glycidol or be copolymerization of glycidol and ethers of glycidol, also named glycidylethers. Glycidol is also named 2,3-epoxy-1-propanol. Examples of glycidolethers suited according to the present invention are glycidylalkylethers like glycidylmethylether and glycidylethylether, and glycidylalkenylethers like glycidylallylether. The polymerization reaction is usually initiated by alkoxides, e.g. potassium methanolate.

The polyethers (a1) are preferably selected from polyglycidylethers and polyalkylene oxides. Preferred polyether (a1) have a number averaged molecular weight (Mn) of at least 200 g/mol, more preferred Mn of the polyethers (a1) is in the range of 1 000 to 30 000 g/mol, even more preferred in the range of 3 000 to 20 000 g/mol. The molecular weight of the polyethers (a1) may be determined via GPC measurement using THF as solvent.

According to the invention preferred polyalkylene oxides used as polyethers (a1) have 1 to 10 OH-groups per molecule, more preferred 2 to 8 OH groups per molecule and most preferred are polyalkylene oxides having 3 to 6 OH groups per molecule. The polyalkylene oxides preferably have a number averaged molecular weight (Mn) of at least 200 g/mol. Preferably Mn of the polyalkylene oxides is in the range of 1 000 to 30 000 g/mol, more preferred in the range of 3 000 to 20 000 g/mol, most preferred in the range of 4 000 to 19 000 of g/mol. The number averaged molecular weight of the polyalkylene oxides may be determined by GPC measurement using THF as solvent.

Preferred polyalkylene oxides used as polyether (a1) according to the invention are homopolymers or copolymers of C₁-C₆ alkylene oxides, i.e. the polyalkylene oxides are homopolymers or copolymers composed of monomeric units selected from (OC₁-C₆ alkylene). Monomeric units (OC₁-C₆ alkylene) include e.g. (OCH₂), (OCH₂CH₂), (OCH₂CH₂CH₂), (OCH₂CH(CH₃)), (OCH₂CH₂CH₂CH₂), (OCH(CH₃)CH(CH₃)), (OCH₂CH(CH₃)CH₂), (OCH₂CH₂CH₂CH₂CH₂), (OCH₂CH₂CH₂CH₂CH₂CH₂), etc. More preferred the polyalkylene oxides are homopolymers or copolymers of C₂-C₄ alkylene oxides and most preferred they are homopolymers or copolymers of C₂-C₃ alkylene oxides. Preferably the polyalkylene oxides used as polyethers (a1) are copolymers of the aforementioned C₁-C₆ alkylene oxides or C₂-C₄ alkylene oxides, more preferred they are copolymers of C₂-C₃ alkylene oxides, in particular preferred they are copolymers of ethylene oxide and 1,2-propylene oxide. The copolymers may be random copolymers or block copolymers, preferred are random copolymers, in particular random copolymers which are liquid at room temperature.

Preferred linear polyglycidylethers for used polyethers (a1) have a number averaged molecular weight of from 4 000 g/mol up to 20 000 g/mol and comprise in average one OH-group per molecule. Preferably the linear polyglycidylethers are composed of glycidylmethylether. Preferred branched polyglycidylethers used as polyether (a1) have a number averaged molecular weight of from 1 000 g/mol up to 80 000 g/mol and a degree of branching of 5 to 70%. The degree of branching is defined according to the method of Frey. Sunder et al., Macromolecules 2000, 33, 7682. Preferred branched polyglycidylethers are copolymers of glycidol and glycidylether, in particular copolymers of glycidol and glycidylmethylether.

Polyether (a1) is reacted with at least one compound (a2) having at least one radically polymerizable C—C double bond and at least one group reactive with the at least one OH-group of the polyether (a1). Compound (a2) is an organic compound having both ethylenic unsaturation and a group reactive with an active hydrogen-containing group. Preferably the reactive group is selected from carboxyl, anhydride, isocyanate, and epoxy.

Representatives of such organic compounds (a2) having ethylenic unsaturation and a reactive group include maleic acid and anhydride, fumaric acid, crotonic acid and anhydride, propenyl succinic anhydride, acrylic acid, acryloyl chloride, hydroxyethyl acrylate or methacrylate, hydroxypropyl acrylate or methacrylate, halogenated maleic acids and anhydrides, unsaturated polyhydric alcohols such as 2-butene-1,4-diol, glycerol allyl ether, trimethylolpropane allyl ether, pentaerythritol allyl ether, pentaerythritol vinyl ether, pentaerythritol diallyl ether, and 1-butene-3,4-diol, unsaturated epoxides such as 1-vinylcyclohexene-3,4,epoxide, butadiene monoxide, vinylglycidyl ether (1-vinyloxy-2,3-epoxy propane), glycidyl methacrylate and 3-allyloxypropylene oxide (allyl glycidyl ether), isocyanates such as isocyanatoethylmethacrylate (IEM) and 1,1-dimethyl meta-isopropenyl benzyl isocyanate (TMI). Preferred compounds (a2) are isocyanatoethylmethacrylate (IEM), 1,1-dimethyl meta-isopropenyl benzyl isocyanate (TMI), and maleic anhydride.

A process for preparing the functionalized polyether (a) is described in detail in WO 2005/003200 A1. In a typical reaction for formation of the functionalized polyether (a) the desired polyether(s) (a1) are reacted with a compound having at least one radically polymerizable C—C double bond and at least one group reactive with the at least one OH-group (a2) in the presence of a Lewis acid catalyst. Preferably the reaction of polyether (a1) and compound (a2) is performed in bulk.

Suitable Lewis acid catalysts generally comprise tin-based, boron-based, aluminum-based, gallium-based, rare earth-based, zinc-based, or titanium-based compounds. Representative tin-based compounds include: dibutyltin diacetate, dibutyltin dibromide, dibutyltin dichloride, dibutyltin dilaurate, dibutyltin dimethoxide, dibutyltin oxide, dimethyltin diacetate, dimethyltin dibromide, diphenyltin dichloride, diphenyltin oxide, methyltin trichloride, phenyltin trichloride, tin(IV) acetate, tin(IV) bromide, tin(IV) chloride, tin(IV) iodide, tin(II) oxide, tin(II) acetate, tin(II) bromide, tin(II) chloride, tin(II) iodide, and tin(II) 2-ethylhexanoate (stannous octoate). Representative boron-based compounds include boron tribromide, boron trichloride, boron trifluoride, and tris(pentafluorophenyl)borane. Representative aluminum-based compounds include: Aluminum chloride and Aluminum bromide. Representative gallium-based compounds include: gallium chloride, gallium bromide, and gallium(III) actylacetonate. Representative rare earth catalysts are generally salts of scandium, yttrium, lanthanum, praseodymium, neodymium, erbium, thulium, ytterbium, neodymium or lutetium. Examples include ytterbium triflate, ytterbium(III) actylacetonate, erbium(III) trifluorosulfonate (erbium triflate), erbium(III) actylacetonate, holmium triflate, terbium triflate, europium triflate, europium(III) trifluroacetate, samarium triflate, neodymium triflate, neodymium(III) actylacetonate, praseodymium triflate, lanthanum triflate, and dysprosium triflate. Representative zinc-based compounds include zinc chloride and zinc bromide. Representative titanium compounds include titanium(IV) bromide and titanium(IV) chloride.

The molar ratio of polyethers (a1) and compounds (a2) used in the reaction is adjusted such that the desired number of polymerizable C—C double bonds is introduced into the functionalized polyether (a).

If a polycarboxylic acid or anhydride is employed to incorporate unsaturation into the polyether (a1), it is preferable to react the unsaturated functionalized polyether (a) with an alkylene oxide, preferably ethylene or propylene oxide, to remove the unreacted acid groups prior to employment as a functionalized polyether (a) in the present invention. The amount of alkylene oxide employed is such as to reduce the acid number of the unsaturated polyol to about 5 or less. If the functionalized polyether (a) obtained from the reaction of polyether (a1) and compound (a2) contains free OH-groups it is possible to protect permanently the remaining OH-groups by derivatization. Permanent protection means within this invention that the derivatization of the OH-groups will be essentially present during the intended use of the polymer, e.g. during its use in an all solid state battery. This permanent protection of free OH-groups has the advantage to reduce the OH-value of the functionalized polyether (a) and in consequence the OH-value of the resulting solid polymer. Free OH groups may have a negative influence if the polymer is used as solid electrolyte in an electrochemical cell. This may be the case for electrochemical cells comprising a metal or metal alloy anode material. According to an embodiment of the present invention the functionalized polyether (a) is the reaction product of the reaction of at least one polyether (a1) having one or more OH-groups and at least one compound (a2) having at least one radically polymerizable C—C double bond and at least one group reactive with the at least one OH-group of the polyether (a1) and a subsequent permanent protection of remaining OH-groups by derivatization.

The derivatization of possibly remaining OH-groups for permanent protection is known to the person skilled in the art and may be performed by reacting the unsaturated functionalized polyether (a) with methyliodide or isocyanates.

Preferred functionalized polyether (a) have an OH-value below 30 mg KOH/g, measured according to DIN 53240 from 2012 (DIN=“Deutsche Industrienorm”, i. e. German industry standard).

A further object of the present invention are random copolymers for use in the solid phase electrolyte composition as described herein, wherein monomer (a) is at least one functionalized polyether (a) containing at least one polymerizable C—C double bond per molecule in average and having an OH-value below 30 mg KOH/g, i.e. random copolymers comprising

5 to 95 wt.-% polymerized units of monomers (a) and

95 to 5 wt.-% polymerized units of monomers (b)

based on the total weight of the random copolymer, wherein
(a) is at least one functionalized polyether containing at least one polymerizable C—C double bond per molecule in average having an OH-value below 30 mg KOH/g, and
(b) is at least one ethylenically unsaturated monomer (b1) or a mixture of at least one ethylenically unsaturated monomer (b1) and at least one ethylenically unsaturated monomer (b2)
   wherein (b1) is selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylacrylic acids, salts of C₁-C₄ alkylacrylic acids, acrylic amides, and vinyl alcohol derivates, preferably (b1) is selected from the group consisting of styrene, alpha-methyl styrene, maleic anhydride, N-phenylmaleimide, C₁-C₄ alkyl methacrylates, C₁-C₂₂ alkyl acrylates, acrylic amides, and vinyl alcohol derivates, and (b2) is selected from the group consisting of acrylonitrile and methacrylonitrile.

The functionalized polyether (a) is used for the preparation of the copolymer. The copolymer is usually prepared by free radical polymerization of at least one polyether (a) and at least one monomer (b) selected from ethylenically unsaturated monomers (b1) or mixtures of at least one ethylenically unsaturated monomer (b1) and at least one ethylenically unsaturated monomer (b2).

Monomers (b1) are selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkyl acrylic acids, salts of C₁-C₄ alkyl acrylic acids, acrylic amides, and vinyl alcohol derivates, preferred is styrene.

Monomers (b2) are selected from the group consisting of acrylonitrile and methacrylonitril.

C₁-C₄ alkyl methacrylates include methyl methacrylate, ethyl methycrylate, isopropyl methacrylate, n-propyl methacrylate and butyl methacrylate etc.

C₁-C₂₂ alkyl acrylates include methyl acrylate, ethyl acrylate, isopropyl acrylate, n-propyl acrylate butyl acrylate, pentyl acrylate, hexyl acrylate, 2-ethylhexyl acrylate, etc.

C₁-C₄ alkyl acrylic acids include methacrylic acid, ethyl acrylic acid, propyl acrylic acid, butyl acrylic acid and the like.

Acrylic amides include N,N-dimethylacrylamide, N,N-dibenzylacrylamide, N-butylacrylamide etc.

Vinyl alcohol derivates include vinyl ethers like vinyl methyl ether, vinyl propyl ethers, vinyl butyl ethers, vinyl 2-ethylhexyl ether, vinylphenyl ether, vinyl 2-methoxyethyl ether, methoxybutadiene, vinyl 2-butoxyethyl ether etc.; and vinylester like vinyl acetate, vinyl butyrate, vinyl acrylate, and vinyl methacrylate and the like.

If monomer (b) is selected from a mixture of at least one monomer (b1) and at least one monomer (b2), the mixture preferably comprises at least 10 wt.-% of monomer (b1), based on the total weight of the monomer (b). Monomer (b1) preferably comprises styrene and most preferred monomer (b1) is styrene.

According to the present invention it is preferred to select monomer (b) from a mixture of at least one monomer (b1) and at least one monomer (b2), more preferred monomer (b) is selected from a mixture of at least one monomer (b1) and acrylonitrile, in particular preferred monomer (b) is a mixture of styrene and acrylonitrile.

Preferably the random copolymer is prepared via free radical polymerization. Free radical polymerization initiators that may be used include the well-known free radical polymerization initiators such as the peroxides, persulfates, perborates, percarbonates, azo compounds, etc. These include hydrogen peroxide, dibenzyoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumene hydroperoxide, paramenthane hydroperoxide, diacetyl peroxide, di-alpha-cumyl peroxide, dipropyl peroxide, diisopropyl peroxide, isopropyl-t-butyl peroxide, butyl-t-butyl peroxide, difuroyl peroxide, bis (triphenylmethyl) peroxide, bis(p-methoxybenzoyl)peroxide, p-monomethoxybenzoyl peroxide, rubene peroxide, ascaridol, t-butyl peroxybenzoate, diethyl peroxyterephthalate, propyl hydroperoxide, isopropyl hydroperoxide, n-butyl hydroperoxide, t-butyl hydroperoxide, cyclohexyl hydroperoxide, trans-decalin hydroperoxide, alpha-methylbenzyl hydroperoxide, alpha-methyl-alpha-ethyl benzyl hydroperoxide, tetralin hydroper-oxide, triphenylmethyl hydroperoxide, diphenylmethyl hydroperoxide, alpha, alpha′-azobis-(2-methylheptonitrile), 1,1′-azobis(cyclohexane carbonitrile), 4,4′ azobis-(4-cyanopentanoic acid), 2,2′-azobis(isobutyronitrile), 1-t-butylazo-1-cyanocyclohexane, persuccinic acid, diisopropyl per-oxydicarbonate, 4,4′-azobis(2,4-dimethylvaleronitrile), 2-t-butylazo-2-cyano-4-methoxy-4-methylpentane, 2,2′-azobis-2-methylbutanenitrile, 2-t-butylazo-2-cyanobutane, 1-t-amylazo-1-cyanocyclohexane, 2,2′-azobis(2,4-dimethyl-4-methoxyvaleronitrile), 2,2′-azobis-2-methylbutyronitrile, 2-t-butylazo-2-cyano-4-methylpentane, 2-t-buylazo-2-isobutyronitrile, 2-butylperoxyisopropyl carbonate, 1,1-tertiary-amylperoxy cyclohexane, tertiary-amylperoxy-2-ethylhexanoate, and the like; a mixture of initiators may also be used. In a preferred embodiment of the present invention a mixture of 1,1-tertiary-amylperoxy cyclohexane and tertiary-amylperoxy-2-ethylhexanoate is used as the initiator.

Generally the polymerization reaction for formation of the random copolymer will employ from about 0.01 wt.-% to about 10 wt.-% of a free radical polymerization initiator based on the total weight of the monomers utilized.

The presence of a reaction moderator during formation of the copolymer is optional, but useful. The reaction moderator is preferably an alcohol, mercaptan, a haloalkane, or mixtures thereof. Among the reaction moderators which may be employed are the following: acetic acid, bromoacetic acid, chloroacetic acid, ethyl dibromoacetate, iodoacetic acid, tribromoacetic acid, ethyl tribromoacetate, trichloroacetic acid, ethyl trichloroacetate, acetone, p-bromophenylacetonitrile, p-nitrophenylacetylene, allyl alcohol, 2,4,6-trinitroaniline, p-ethynylanisole, 2,4,6-trinitroanisole, azobenzene, benzaldehyde, p-cyanobenzaldehyde, 2-butylbenzene, bromobenzene, 1,3,5-trinitrobenzene, benzochrysene, ethyl trinitrobenzoate, benzoin, benzonitrile, benzopyrene, tributylborane, 1,4-butanediol, 3,4-epoxy-2-methyl-1-butene, t-butyl ether, t-butyl isocyanate, 1-phenylbutyne, p-cresol, p-bromocumene, dibenzonaphthacene, p-dioxane, pentaphenyl ethane, ethanol, 1,1-diphenylethylene, ethylene glycol, ethyl ether, fluorene, N,N-dimethylformamide, 2-heptene, 2-hexene, isobutylraldehyde, diethyl bromomalonate, bromotrichloromethane, dibromoethane, diiodomethane, naphthalene, 1-naphthol, 2-napthol, methyl oleate, 2,4,4-triphenyl-1-pentene, 4-methyl-2-pentene, 2,6-diisopropylphenol, phenyl ether, phenylphosphine, diethyl-phosphine, dibutylphosphine, phosphorus trichloride, 1,1,1-tribromopropane, dialkyl phthalate, 1,2-propanediol, 3-phosphinopropionitrile, 1-propanol, pyrocatechol, pyrogallol, 1,4-benzoquinone, methyl stearate, tetraethylsilane, triethylsilane, dibromostilbene, alpha-bromostyrene, alpha-methylstyrene, tetraphenyl succinonitrile, 2,4,6-trinitrotoluene, p-toluidine, N,N-dimethyl-p-toluidine, alpha-cyano-p-tolunitrile, alpha,alpha′-dibromo-p-xylene, 2,6-xylenol, diethyl zinc, dithiodiacetic acid, ethyl dithiodiacetic acid, 4,4′-dithio-bisanthranilic acid, benzenethiol, o-ethoxybenzenethiol, 2,2′-dithiodiacetic acid, 4,4′-dithio-bisanthranilic acid, benzenethiol, o-ethoxybenzenethiol, 2,2′-dithiobisbenzothiazole, benzyl sulfide, 1-dodecanethiol, ethanethiol, 1-hexanethiol, 1-napthalenethiol, 2-naphthalenethiol, 1-octanethiol, 1-heptanethiol, 2-octanethiol, 1-tetradecanethiol, benzyl thiol, isopropanol, 2-butanol, carbon tetrabromide, bromotrichloromethane, tertiary-dodecylmercaptan, and any combination of the above compounds. Preferred reaction moderators are 2-propanol, 2-butanol, and mixtures thereof. The amount of reaction moderator that is employed preferably ranges from 0.5 to 25 weight percent, based on the total weight of the monomers.

The free radical polymerization may be performed in bulk or in the presence of a solvent or solvent mixture. The solvents may be selected from dimethylformamide, ethylbenzene, 1,4-dioxane, dimethylformamide, N-methyl-2-pyrrolidone, tetrahydrofurane, dimethylsulfoxide, diethyl ether, diethylene glycol, pyridine, ethylene glycol, toluene, styrene, and benzene. Usually the concentration of monomers (a) and (b) in the solvent(s) is in the range of 20 to 80 wt.-%, preferred in the range of 25 to 55 wt.-%, based on the total weight of monomers (a), monomers (b) and solvent. Preferred solvents are ethylbenzene, 1,4-dioxane, N-methyl-2-pyrrolidone, and styrene.

According to one embodiment of the present invention the polymerization is performed in the presence of a solvent or mixture of solvent. It is preferred that the solvent or mixture of solvent used in the free radical polymerization of functionalized polyether (a) and ethylenically unsaturated monomers (b) is different from polyetherpolyols. It is in particular preferred to use a solvent or mixture of solvents which have a melting point below 10° C., preferred solvents are ethylbenzene, 1,4-dioxane, N-methyl-2-pyrrolidone, and styrene. Evaporation may be accelerated by use of vacuum and/or heat during the evaporation. The use of such solvents has the advantage, that the reaction mixture containing the random copolymer resulting from the polymerization reaction can be directly used for preparing the solid phase electrolyte, e.g. by adding a conducting salt to the mixture of the random copolymer and subsequently coating a carrier or an article used in an electrochemical cell like an anode or a cathode with this solution. Afterwards the solvent(s) can be removed yielding a film of the solid phase electrolyte. It is also possible to precipitate the random copolymer from the reaction mixture by usual methods known by the person skilled in the art, e.g. by evaporation of the solvent(s) or by adding the random copolymer solution into a non-solvent for the copolymer and thereby precipitating the copolymer.

A further object of the present invention is therefore a process for preparing the random copolymers as described herein comprising the steps
(i) reacting in bulk at least one polyether (a1) having one or more OH-groups and at least one compound (a2) having at least one radically polymerizable C—C double bond and at least one group reactive with the at least one OH-group of the polyether (a1) to obtain at least one functionalized polyether (a);
(ii) optionally permanent protection of remaining OH-groups of the functionalized polyether (a) by derivatization;
(iii) radically copolymerizing the functionalized polyether (a) from step (i) or (ii) and at least one ethylenically unsaturated monomer (b1) or a mixture of at least one ethylenically unsaturated monomer (b1) and at least one ethylenically unsaturated monomer (b2) in a reaction mixture containing a solvent that is different from polyetherpolyols and a free radical initiator to obtain the copolymer; and
(iv) optionally precipitating the copolymer.

The amount of functionalized polyethers (a) employed in the preparation of the copolymer is generally from 5 to 95 wt.-%; preferably more than 10 to 95 wt.-%, more preferred 20 to 80 wt.-%, based on the total weight of the copolymer.

The random copolymer comprises

5 to 95 wt.-% polymerized units of monomers (a) and

95 to 5 wt.-% polymerized units of monomers (b),

based on the total weight of the copolymer, wherein it is preferred that the amount of polymerized units of monomers (a) and polymerized units of monomers (b) add up to 100 wt.-%.

Preferably the random copolymer comprises

10 to 95 wt.-% polymerized units of monomers (a) and

90 to 5 wt.-% polymerized units of monomers (b),

based on the total weight of the copolymer, wherein it is preferred that the amount of polymerized units of monomers (a) and polymerized units of monomers (b) add up to 100 wt.-%.

More preferred the random copolymer comprises

20 to 80 wt.-% polymerized units of monomers (a) and

80 to 20 wt.-% polymerized units of monomers (b),

based on the total weight of the copolymer, wherein it is preferred that the amount of polymerized units of monomers (a) and polymerized units of monomers (b) add up to 100 wt.-%.

Most preferred the random copolymer comprises

30 to 70 wt.-% polymerized units of monomers (a) and

70 to 30 wt.-% polymerized units of monomers (b),

based on the total weight of the copolymer, wherein it is preferred that the amount of polymerized units of monomers (a) and polymerized units of monomers (b) add up to 100 wt.-%.

The copolymers obtained by free radical polymerization of functionalized polyether (a) and ethylenically unsaturated monomers (b) are random copolymers, i.e. the different monomer units resulting from the functionalized polyethers (a) and ethylenically unsaturated monomers (b) are distributed randomly in the copolymer chains. The random distribution of the monomer units in the copolymer has the advantage that less crystallization occurs in comparison to copolymers containing the same monomers arranged as blocks or even no crystallization of the copolymer occurs. It is known that in solid polymer electrolyte based on polyethers the ion conduction mainly takes place the amorphous parts of the polymer, see e.g. page 4406 of K. Xu, Chem. Rev. 104 (2004), pages 4303 to 4417. So in case of polymer electrolytes based on polyethers a low degree of crystallinity is desired. The inventive copolymer combines amorphous “soft” phases composed mainly by monomer units derived from the functionalized polyethers (a) capable of ion conduction and “hard” phases composed mainly of monomer units derived from the ethylenically unsaturated monomers (b) imparting mechanical strength to the copolymer.

Preferably functionalized polyethers (a) having one polymerizable C—C double bond per molecule in average are used for preparing the random copolymers, which are prepared from a polyether (a1) having more than one OH groups. The non-functionalized OH-groups may be permanently protected. The optionally protected OH-carrying groups present in the functionalized polyether (a) are incorporated into the random copolymer and may be helpful in the phase separation of the random copolymer into hard and soft phases thereby enhancing the conductivity and/or mechanical strength of the copolymer.

A further object of the present invention is the use of random copolymers as described herein comprising

5 to 95 wt.-% polymerized units of monomers (a) and

95 to 5 wt.-% polymerized units of monomers (b),

based on the total weight of the copolymer,

wherein
(a) is at least one functionalized polyether containing at least one polymerizable C—C double bond per molecule in average, and
(b) is at least one ethylenically unsaturated monomer (b1) or a mixture of at least one ethylenically unsaturated monomer (b1) and at least one ethylenically unsaturated monomer (b2)
   wherein (b1) is selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylacrylic acids, salts of C₁-C₄ alkylacrylic acids, acrylic amides, and vinyl alcohol derivates, and
   (b2) is selected from the group consisting of acrylonitrile and methacrylonitrile.

in electrochemical cells, preferably in electrolytes for electrochemical cells and most preferred in solid phase electrolytes for electrochemical cells.

The inventive solid phase electrolyte composition contains at least one conducting salt. The solid phase electrolyte composition functions as a medium that transfers ions participating in the electrochemical reaction taking place in an electrochemical cell. Preferably the conducting salt is selected from conducting salts containing alkali metal ion like Li⁺, Na⁺ and K⁺, more preferred the at least one conducting salt a lithium salt.

Lithium conducting salts may be
Li[F₆₋ₓP(C_{y}F_{2y+1})ₓ], wherein x is an integer in the range from 0 to 6 and y is an integer in the range from 1 to 20;
Li[B(R′)₄], Li[B(R′)₂(OR″O)] and Li[B(OR″O)₂] wherein each R′ is independently from each other selected from F, Cl, Br, I, C₁-C₄ alkyl, C₂-C₄ alkenyl, C₂-C₄ alkynyl, OC₁-C₄ alkyl, OC₂-C₄ alkenyl, and OC₂-C₄ alkynyl wherein alkyl, alkenyl, and alkynyl may be substituted by one or more OR″′, wherein R″′ is selected from C₁-C₆ alkyl, C₂-C₆ alkenyl, and C₂-C₆ alkynyl, and
(OR″O) is a bivalent group derived from a 1,2- or 1,3-diol, a 1,2- or 1,3-dicarboxylic acid or a 1,2- or 1,3-hydroxycarboxylic acid, wherein the bivalent group forms a 5- or 6-membered cycle via the both oxygen atoms with the central B-atom;
LiClO₄; LiAsF₆; LiCF₃SO₃; Li₂SiF₆; LiSbF₆; LiAlCl₄, LiN(SO₂F)₂, lithium tetrafluoro (oxalato) phosphate; lithium oxalate; and
salts of the general formula Li[Z(CₙF₂ₙ₊₁SO₂)ₘ], where m and n are defined as follows:
m=1 when Z is selected from oxygen and sulfur,
m=2 when Z is selected from nitrogen and phosphorus,
m=3 when Z is selected from carbon and silicon, and
n is an integer in the range from 1 to 20.

Suited 1,2- and 1,3-diols from which the bivalent group (OR″O) is derived may be aliphatic or aromatic and may be selected, e.g., from 1,2-dihydroxybenzene, propane-1,2-diol, butane-1,2-diol, propane-1,3-diol, butan-1,3-diol, cyclohexyl-trans-1,2-diol and naphthalene-2,3-diol which are optionally are substituted by one or more F and/or by at least one straight or branched non fluorinated, partly fluorinated or fully fluorinated C₁-C₄ alkyl group. An example for such 1,2- or 1,3-diole is 1,1,2,2-tetra(trifluoromethyl)-1,2-ethane diol.

“Fully fluorinated C₁-C₄ alkyl group” means, that all H-atoms of the alkyl group are substituted by F.

Suited 1,2- or 1,3-dicarboxlic acids from which the bivalent group (OR″O) is derived may be aliphatic or aromatic, for example oxalic acid, malonic acid (propane-1,3-dicarboxylic acid), phthalic acid or isophthalic acid, preferred is oxalic acid. The 1,2- or 1,3-dicarboxlic acid are optionally substituted by one or more F and/or by at least one straight or branched non fluorinated, partly fluorinated or fully fluorinated C₁-C₄ alkyl group.

Suited 1,2- or 1,3-hydroxycarboxylic acids from which the bivalent group (OR″O) is derived may be aliphatic or aromatic, for example salicylic acid, tetrahydro salicylic acid, malic acid, and 2-hydroxy acetic acid, which are optionally substituted by one or more F and/or by at least one straight or branched non fluorinated, partly fluorinated or fully fluorinated C₁-C₄ alkyl group. An example for such 1,2- or 1,3-hydroxycarboxylic acids is 2,2-bis(trifluoromethyl)-2-hydroxy-acetic acid.

Examples of Li[B(R′)₄], Li[B(R′)₂(OR″O)] and Li[B(OR″O)₂] are LiBF₄, lithium difluoro oxalato borate and lithium dioxalato borate.

Most preferably, the salt is lithium bis(trifluoromethanesulfonyl)imide (LiTFSI; LiN(SO₂CF₃)₂] The at least one conducting salt is usually present at a concentration of at least 0.01 wt.-%, preferably of at least 1 wt.-%, and more preferred of at least 5 wt.-%, based on the total weight of the solid phase electrolyte composition. Usually the upper concentration limit for the at least one conducting salt is 25 wt.-%, based on the total weight of the solid phase electrolyte composition.

The solid phase electrolyte composition may contain further components like additional polymers and additives. Additional polymers may be selected from thermoplastic polymers like polystyrene (PS), copolymers of styrene and acrylonitrile (PSAN), polyamides, polyvinylidene difluoride (PVDF) and polyvinylchloride (PVC), which participate in the formation of the hard phases of the solid electrolyte composition. Additional polymers may also be selected from ion conductive polymers like polyalkylene oxides, linear and branched polyglycidylethers, and lithiated polyelectrolytes like the Li-salt of polyacrylic acid.

According to one embodiment of the present invention the solid phase electrolyte composition additionally contains at least one polyalkyleneoxide. Preferred are homopolymers or copolymers of C₁-C₆ alkylene oxides, i.e. the polyalkylene oxides are homopolymers or copolymers composed of monomeric units selected from (OC₁-C₆ alkylene). Monomeric units (OC₁-C₆ alkylene) include e.g. (OCH₂), (OCH₂CH₂), (OCH₂CH₂CH₂), (OCH₂CH(CH₃)), (OCH₂CH₂CH₂CH₂), (OCH(CH₃)CH(CH₃)), (OCH₂CH(CH₃)CH₂), (OCH₂CH₂CH₂CH₂CH₂), (OCH₂CH₂CH₂CH₂CH₂CH₂), etc. More preferred the polyalkylene oxides are homopolymers or copolymers of C₁-C₄ alkylene oxides and most preferred they are homopolymers or copolymers of C₂-C₃ alkylene oxides. Preferred are copolymers of the aforementioned C₁-C₆ alkylene oxides or C₁-C₄ alkylene oxides, more preferred are copolymers of C₂-C₃ alkylene oxides, in particular preferred they are copolymers of ethylene oxide and 1,2-propylene oxide. The copolymers may be random copolymers or block copolymers, preferred are random copolymers.

Polyalkylene oxides contained in the solid phase electrolyte composition preferably have a number averaged molecular weight of 200 to 2 000 000 g/mol, preferred 2 000 to 1 000 000 g/mol, as can be measured by GPC in tetrahydrofurane.

If the solid phase electrolyte contains one or more additional ion conductive polymers like polyalkylene oxides, the concentration of the additional ion conductive polymers in total is usually 1 to 50 wt.-%, preferred 5 to 25 wt.-%, and more preferred 10 to 15 wt.-%, based on the total weight of the solid phase electrolyte.

The inventive solid phase electrolyte composition may also contain at least one additional polymer selected from thermoplastics and at least one additional polymer selected from ion conductive polymers. If the solid phase electrolyte contains at least one additional polymer selected from thermoplastics and at least one additional copolymer selected from ion conductive polymers the total concentration of thermoplastic(s) and ion conductive polymer(s) is usually 1 to 50 wt.-%, more preferred 5 to 25 wt.-%, and most preferred 10 to 15 wt.-%, based on the total weight of the solid phase electrolyte.

The inventive solid phase electrolyte may contain additional additives, e.g. wetting agents, primer, and plasticizers like oligomeric polyethylene oxides, diglyme (diethyleneglycoldimethylether), triglyme (triethylenglycoldimethylether) and cyclic polyethers.

The inventive solid phase electrolyte composition usually contains at least 25 wt.-% of the at least one random copolymer, preferably it contains at least 50 wt.-% and more preferred at least 75 wt.-% of the at least one random copolymer, based on the total weight of the solid phase electrolyte composition.

The total concentration of conducting salt(s), one or more random copolymers as described above and optionally one or more additional polymers in the solid phase electrolyte composition is usually above 91 wt.-%, preferred at least 92 wt.-%, even more preferred at least 95 wt.-%, more preferred at least 98 wt.-% and most preferred at least 99 wt.-%, based on the total weight of the solid phase electrolyte composition.

The solid phase electrolyte composition may be prepared by adding conducting salt(s), optionally additional ion conductive and/or thermoplastic polymer(s) and optionally additional additive(s) like wetting agents, plasticizers, and primers to a solution of at least copolymer as described above. The solution of the at least one copolymer may be the reaction mixture obtained after the free radical polymerization of monomers (a) and (b) or it may be a solution prepared from the precipitated copolymer and a solvent or solvent mixture. It is also possible to mix copolymer(s), conducting salt(s) and possible additional components like additional polymer(s) and additional additive(s) in the melt.

Another object of the present invention is an electrochemical cell comprising

(A) the solid phase electrolyte composition as described above,

(B) at least one cathode comprising at least one cathode active material, and

(C) at least one anode comprising at least one anode active material.

Preferably the at least one anode active material comprises an alkali metal or alkali metal alloy like sodium or lithium or alloys of lithium or sodium.

Preferably the electrochemical cell is a lithium battery, i.e. an electrochemical cell, wherein the anode comprises lithium metal or lithium ions sometime during the charge/discharge of the cell. The anode may comprise lithium metal or a lithium metal alloy or lithium containing compounds like a material incorporating and releasing lithium ions. Examples of such electrochemical cells are electrochemical cells comprising lithium metal or lithium alloy as anode active material like lithium metal batteries and lithium ion secondary batteries. Preferably the electrochemical cell is a lithium ion secondary battery. A secondary lithium ion electrochemical comprises a cathode comprising a cathode active material that can reversibly occlude and release lithium ions and an anode comprising an anode active material that can reversibly occlude and release lithium ions. The terms “secondary lithium ion electrochemical cell” and “(secondary) lithium ion battery” are used interchangeably within the present invention.

The at least one cathode active material preferably comprises a material capable of occluding and releasing lithium ions selected from lithiated transition metal phosphates and lithium ion intercalating transition metal oxides.

Examples of lithiated transition metal phosphates are lithium iron phosphates and LiCoPO₄, examples of lithium ion intercalating transition metal oxides are transition metal oxides with layer structure having the general formula (X) Li_{(1+z)}[NiₐCo_{b}Mn_{c}]_{(1-z)}O₂₊ₑ wherein z is 0 to 0.3; a, b and c may be same or different and are independently 0 to 0.8 wherein a+b+c=1; and −0.1≦e≦0.1, and manganese-containing spinels of general formula (XI) Li₁₊ₜM₂₋ₜO_{4-d} wherein d is 0 to 0.4, t is 0 to 0.4 and M is Mn and at least one further metal selected from the group consisting of Co and Ni, and Li_{(1+g)}[NiₕCoᵢAlⱼ]_{(1-g)}O₂₊ₖ. Typical values for g, h, I, j and k are: g=0, h=0.8 to 0.85, i=0.15 to 0.20, j=0.02 to 0.03 and k=0.

The cathode may further comprise electrically conductive materials like electrically conductive carbon and usual components like binders. Compounds suited as electrically conductive materials and binders are known to the person skilled in the art. For example, the cathode may comprise carbon in a conductive polymorph, for example selected from graphite, carbon black, carbon nanotubes, graphene or mixtures of at least two of the aforementioned substances. In addition, the cathode may comprise one or more binders, for example one or more organic polymers like polyethylene, polyacrylonitrile, polybutadiene, polypropylene, polystyrene, polyacrylates, polyvinyl alcohol, polyisoprene and copolymers of at least two comonomers selected from ethylene, propylene, styrene, (meth)acrylonitrile and 1,3-butadiene, especially styrene-butadiene copolymers, and halogenated (co)polymers like polyvinlyidene chloride, polyvinyl chloride, polyvinyl fluoride, polyvinylidene fluoride (PVdF), polytetrafluoroethylene, copolymers of tetrafluoroethylene and hexafluoropropylene, copolymers of tetrafluoroethylene and vinylidene fluoride and polyacrylnitrile.

Furthermore, the cathode may comprise a current collector which may be a metal wire, a metal grid, a metal web, a metal sheet, a metal foil or a metal plate. A suited metal foil is aluminum foil.

The anode active material may be selected from compounds that can reversibly occlude and release lithium ions. In particular carbonaceous material that can reversibly occlude and release lithium ions can be used as anode active material. Carbonaceous materials suited are crystalline carbon such as a graphite material, more particularly, natural graphite, graphitized cokes, graphitized MCMB, and graphitized MPCF; amorphous carbon such as coke, mesocarbon microbeads (MCMB) fired below 1500° C., and mesophase pitch-based carbon fiber (MPCF); hard carbon and carbonic anode active material (thermally decomposed carbon, coke, graphite) such as a carbon composite, combusted organic polymer, and carbon fiber.

Further anode active materials are lithium metal, or materials containing an element capable of forming an alloy with lithium. Non-limiting examples of materials containing an element capable of forming an alloy with lithium include a metal, a semimetal, or an alloy thereof. It should be understood that the term “alloy” as used herein refers to both alloys of two or more metals as well as alloys of one or more metals together with one or more semimetals. If an alloy has metallic properties as a whole, the alloy may contain a nonmetal element. In the texture of the alloy, a solid solution, a eutectic (eutectic mixture), an intermetallic compound or two or more thereof coexist. Examples of such metal or semimetal elements include, without being limited to, titanium (Ti), tin (Sn), lead (Pb), aluminum, indium (In), zinc (Zn), antimony (Sb), bismuth (Bi), gallium (Ga), germanium (Ge), arsenic (As), silver (Ag), hafnium (Hf), zirconium (Zr) yttrium (Y), and silicon (Si). Metal and semimetal elements of Group 4 or 14 in the long-form periodic table of the elements are preferable, and especially preferable are titanium, silicon and tin, in particular silicon. Examples of tin alloys include ones having, as a second constituent element other than tin, one or more elements selected from the group consisting of silicon, magnesium (Mg), nickel, copper, iron, cobalt, manganese, zinc, indium, silver, titanium (Ti), germanium, bismuth, antimony and chromium (Cr). Examples of silicon alloys include ones having, as a second constituent element other than silicon, one or more elements selected from the group consisting of tin, magnesium, nickel, copper, iron, cobalt, manganese, zinc, indium, silver, titanium, germanium, bismuth, antimony and chromium.

A further possible anode active material is silicon which is able to intercalate lithium ions. The silicon may be used in different forms, e.g. in the form of nanowires, nanotubes, nanoparticles, films, nanoporous silicon or silicon nanotubes. The silicon may be deposited on a current collector. The current collector may be a metal wire, a metal grid, a metal web, a metal sheet, a metal foil or a metal plate. Preferred the current collector is a metal foil, e.g. a copper foil. Thin films of silicon may be deposited on metal foils by any technique known to the person skilled in the art, e.g. by sputtering techniques. One possibility of preparing Si thin film electrodes are described in R. Elazari et al.; Electrochem. Comm. 2012, 14, 21-24. It is also possible to use a silicon/carbon composite as anode active material according to the present invention.

Other possible anode active materials are lithium ion intercalating oxides of Ti.

Preferably the anode active material present in the inventive electrochemical is selected from carbonaceous material that can reversibly occlude and release lithium ions, particularly preferred the carbonaceous material that can reversibly occlude and release lithium ions is selected from crystalline carbon, hard carbon and amorphous carbon, in particular preferred is graphite. In another preferred embodiment the anode active material present in the inventive electrochemical cell is selected from silicon that can reversibly occlude and release lithium ions, preferably the anode comprises a thin film of silicon or a silicon/carbon composite. In a further preferred embodiment the anode active material present in the inventive electrochemical cell is selected from lithium ion intercalating oxides of Ti.

The anode and cathode may be made by preparing an electrode slurry composition by dispersing the electrode active material, a binder, optionally a conductive material and a thickener, if desired, in a solvent and coating the slurry composition onto a current collector. The current collector may be a metal wire, a metal grid, a metal web, a metal sheet, a metal foil or a metal plate. Preferred the current collector is a metal foil, e.g. a copper foil or aluminum foil.

The inventive electrochemical may contain further constituents customary per se, for example separators, housings, cable connections etc. The housing may be of any shape, for example cuboidal or in the shape of a cylinder, the shape of a prism or the housing used is a metal-plastic composite film processed as a pouch. Suited separators are for example glass fiber separators and polymer-based separators like polyolefin separators.

Several inventive electrochemical cells may be combined with one another, for example in series connection or in parallel connection. Series connection is preferred. The present invention further provides for the use of inventive electrochemical cells as described above in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers. But the inventive electrochemical cells can also be used for stationary energy stores.

The invention is illustrated by the examples which follow, which do not, however, restrict the invention.

### EXAMPLES

I. Preparation of Functionalized Polyether

Functionalized Polyether 1

Functionalized polyether 1 (FP1) was formed by first charging to a reactor a polyol having in average 6 OH-groups per molecule based on sorbitol as a starter and a number averaged molecular weight of about 18 000 g/mol, consisting mainly of propylene oxide as a monomer and 50 ppm dibutyltin dilaurate (T-12) catalyst at room temperature. The mixture was heated to 80° C. and the TMI (1,1-dimethyl meta-isopropenyl benzyl isocyanate) was added dropwise to the mixture over 0.5 hours. Approximately 0.36 to 0.4 moles of TMI were added to each mole of polyol in the final functionalized polyethers (a1). The mixture was allowed to react another hour after completion of the addition. Essentially all of the unsaturation was retained in the resulting functionalized polyether 1.

Functionalized Polyether 2

Functionalized polyether 2 (FP 2) was formed according to the procedure described for functionalized polyether 1, except that a polyol having 3 OH groups per molecule based on glycerine as a starter and a number averaged molecular weight of about 5 000 g/mol consisting mainly of propylene oxide as a monomer, was used.

Functionalized Polyether 3

Functionalized polyether 3 (FP 3) was formed according to the procedure described for functionalized polyether 1, except that a polyol having 1 OH groups per molecule based on methanol as a starter and a number averaged molecular weight of about 3 000 g/mol consisting mainly of ethylene oxide as a monomer, was used. Approximately 0.995 moles of TMI were added to each mole of polyol in the final functionalized polyethers.

II. Preparation of the Copolymers

The 75 g of a mixture of the desired functionalized polyether and ethylenically unsaturated monomers (b) selected from styrene (abbreviated S) and acrylonitrile (abbreviated AN), 75 g dimethyl formamide, and 0.3 g 2,2′-azodiisobutyronitrile (AIBN) were added into a glass flask and were heated up to 75° C. under nitrogen atmosphere. The reaction mixture was stirred. The polymerization reaction was carried out at this temperature until the reaction mixture became viscous. The conversion was determined by determining the solid content of the reaction mixture obtained. Depending on the monomers the reaction time was between 15 min and 8 h.

After cooling the reaction mixture was poured slowly under vigorous stirring into methanol. Depending on its composition the copolymer precipitates as fine white powder or as a gel like residue. The supernatant methanol was removed and the solid residue was washed two times with methanol. The solid obtained was sucked and dried in vacuum at 80° C.

The number averaged molecular weight was determined via GPC in tetrahydrofurane with universal calibration based on polystyrene.

The copolymers prepared and their compositions are summarized in Table 1.

III. Conductivities of the Copolymers

In a typical experiment, the dried copolymer powder or comparative polymer was dissolved in solvents like 1,3-dioxolane (DOL), methyl ethyl ketone (MEK) or 1,2-dimethoxy ethane (DME). The conductive salt lithium bis(trifluoromethanesulfonyl)imide was added to this solution in the desired amount and the concentration adjusted such that viscosity would allow for doctor blading which required usually a 20-50 wt.-% solution. Optionally additives can be mixed to the solution, for instance, wetting agents, plasticizers, primers, etc. Doctor blading was either accomplished manually or automatically using an Erichson K101 coater. The coating substrate for dry state ionic conductivity measurements was a glass plate carefully cleaned and dried prior to processing. After slow evaporating the solvent under ambient temperature the resulting films were completely dried in a vacuum oven at 50° C. over night. The conductivity measurements were performed in a glove box to avoid influence of moisture. Ionic conductivities were determined by impedance spectroscopy at various temperatures using a Zahner-Elektrik device working in the four-point measurement mode. Gold electrodes were employed. The results are shown in Table 1. The ratios of the monomers are given in wt.-%.

The polystyrene of comparative example 1 had a number averaged molecular weight of 158 000 g/mol. The polyamide of comparative example 2 was poly(epsilon-caprolactame) having a degree of polymerization of 150 to 250 and a melt viscosity of 100 to 250 Pa*s determined at 250° C. and at a shear rate of 1000 s⁻¹.

TABLE 1
Ionic conductivities of films of solid phase electrolyte
composition comprising 7.5 wt.-% conductive salt

| | | | Specific | Film |
|---|---|---|---|---|
| | | T | conductivity | thickness |
| Example | Materials | [° C.] | [S/cm] | [μm] |
| Example 1 | S/FP 1 | 23 | 6.7 * 10⁻⁷ | 10 |
| | 35/65 | | | |
| Example 2 | S/AN/FP 1 | 23 | 2.7 * 10⁻⁷ | 10 |
| | 7/3/90 | | | |
| Example 3 | S/AN/FP 1 | 23 | 4.6 * 10⁻¹⁰ | 10 |
| | 53/37/10 | | | |
| Example 4 | S/AN/FP 2 | 23 | 2.3 * 10⁻¹⁰ | 10 |
| | 50/40/10 | | | |
| Example 5 | S/AN/FP3 | 80 | 4.6 * 10⁻⁵ | 10 |
| | 33/17/50 | | | |
| Comperative | S | 23 | 3.6 * 10⁻¹¹ | 8 |
| Example 1 | | | | |
| Comperative | Ultramid B33 | 55 | 1.8 * 10⁻¹¹ | 10 |
| Example 2 | | | | |

1. A solid phase electrolyte composition, comprising:
at least one conducting salt and at least one random copolymer, wherein the random copolymer comprises
5 to 95 wt.-% polymerized units of a monomer (a) and
95 to 5 wt.-% polymerized units of a monomer (b),
based on the total weight of the copolymer,
wherein
the monomer (a) is at east one functionalized polyether containing comprising at least one polymerizable C—C double bond per molecule in average, and
the monomer (b) is at least one ethylenically unsaturated monomer (b1) or a mixture of at least one ethylenically unsaturated monomer (b1) and at least one ethylenically unsaturated monomer (b2),
wherein the ethylenically unsaturated monomer (b1) is at least one selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylactylic acids, salts of C₁-C₄ alkylacrylic acids, acrylic amides, and vinyl alcohol derivatives, and
the ethylenically unsaturated monomer (b2) is at least one selected from the group consisting of acrylonitrile and methacrylonitrile.

2. The solid phase electrolyte composition according to claim 1, wherein the functionalized polyether monomer (a) is a reaction product of a reaction of at least one polyether (a1) comprising one or more OH-groups and at least one compound (a2) comprising at least one radically polymerizable C—C double bond and at least one group reactive with the at least one OH-group of the polyether (a1).

3. The solid phase electrolyte composition according to claim 2, wherein the polyether (a1) is at least one selected from the group consisting of polyglycidylethers and polyalkylene oxides.

4. The solid phase electrolyte composition according to claim 2, wherein the polyether (a1) is a polyalkylene oxide comprising 2-8 OH-groups per molecule.

5. The solid phase electrolyte composition according to claim 2, wherein the polyether (a1) is a homopolymer or copolymer of C₁-C₆ alkylene oxides.

6. The solid phase electrolyte composition according to claim 2, wherein the polyether (a1) has a number average molecular weight in the range of 1000 to 30000 g/mol.

7. The solid phase electrolyte composition according to claim 2, wherein the reactive group of the at least one compound (a2) is at least one selected from the group consisting of isocyanate, epoxy, carboxyl and anhydride.

8. The solid phase electrolyte composition according to claim 1, wherein the functionalized polyether monomer (a) has an OH-value below 30 mg KOH/g.

9. The solid phase electrolyte composition according to claim 1, wherein the solid phase electrolyte composition comprises contains at least one polyalkyleneoxide.

10. The solid phase electrolyte composition according to claim 1, wherein the at least one conducting salt is selected from conducting salts comprising an alkali metal ion.

11. An electrochemical cell, comprising:
(A) the solid phase electrolyte composition according to claim 1,
(B) at least one cathode comprising at least one cathode active material, and
(C) at least one anode comprising at least one anode active material.

12. The electrochemical cell according to claim 11, wherein the at least one anode active material comprises an alkali metal or an alkali metal alloy.

13. The electrochemical cell according to claim 11, wherein the electrochemical cell is a lithium battery.

14. A method for producing an electrochemical cell, the method comprising:
incorporating a solid phase electrolyte composition into an electrochemical cell, the composition comprising at least one conducting salt and at least one random copolymer, wherein the random copolymer comprises
5 to 95 wt.-% polymerized units of a monomer (a) and
95 to 5 wt.-% polymerized units of a monomer (b),
based on the total weight of the copolymer,
wherein
the monomer (a) is at least one functonalized polyether comprising at least one polymerizable C—C double bond per molecule in average, and
the monomer (b) is at least one ethylenically unsaturated monomer (b1) or a mixture of at least one ethylenically unsaturated monomer (b1) and at least one ethylenically unsaturated monomer (b2),
wherein the ethylenically unsaturated monomer (b1) is at least one selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylacrylic acids, salts of C₁-C₄ alkylacrylic acids, acrylic amides, and vinyl alcohol derivatives, and
the ethylenically unsaturated monomer (b2) is at least one selected from the group consisting of acrylonitrile and methacrylonitrile.

15. A random copolymer, comprising:
5 to 95 wt.-% polymerized units of a monomer (a) and
95 to 5 wt.-% polymerized units of a monomer (b),
based on the total weight of the copolymer,
wherein
the monomer (a) is at least one functionalized polyether comprising at least one polymerizable C—C double bond per molecule in average, and
the monomer (b) is at least one ethylenically unsaturated monomer (b1) or a mixture of at least one ethylenically unsaturated monomer (b1) and at least one ethylenically unsaturated monomer (b2),
wherein the ethylenically unsaturated monomer (1) is at least one selected from the group consisting of styrene, alpha-methyl styrene, maleic anhydride, N-phenylmaleimide, C₁-C₄ alkyl methacrylates, C₁-C₂₂ alkyl acrylates, acrylic acid, salts of acrylic acid, C₁-C₄ alkylacrylic acids, salts of C₁-C₄ alkylacrylic acids, acrylic amides, and vinyl alcohol derivatives, and
the ethylenically unsaturated monomer (b2) is at least one selected from the group consisting of acrylonitrile and methacrylonitrile.

16. A process for preparing the random copolymer according to claim 15, comprising:
reacting in bulk at least one polyether (a1) comprising one or more OH-groups and at least one compound (a2) comprising at least one radically polymerizable C—C double bond and at least one group reactive with the at least one OH-group of the polyether (a1) to obtain the at least one functionalized polyether monomer (a); and
radically copolymerizing the functionalized polyether monomer (a) and at least one ethylenically unsaturated monomer (b1) or a mixture of at least one ethylenically unsaturated monomer (b1) and at least one ethylenically unsaturated monomer (b2) in a reaction mixture the reaction mixture comprising a solvent that is not a polyetherpolvol and a free radical initiator to obtain the copolymer.

17. The solid phase electrolyte composition according to claim 1, wherein the functionalized polyether monomer (a) is a reaction product of a reaction of at least one polyether (a1) comprising one or more OH-groups and at least one compound (a2) comprising at least one radically polymerizable C—C double bond and at least one group reactive with the at least one OH-group of the polyether (a1) and a subsequent permanent protection of remaining OH-groups by derivatization.

18. The process according to claim 16, further comprising permanently protecting remaining OH-groups of the obtained functionalized polyether monomer (a) by derivatization after the reacting in bulk and before the radically copolymerizing.

19. The process according to claim 16, further comprising precipitating the obtained copolymer after the radically copolymerizing.
